(19) United States
(12) Patent Application Publication
(10) Pub. No.: US 2025/0001824 A1
(43) Pub. Date: Jan. 2, 2025

(54) ARTICULATING LEAF SPRING SUSPENSION ASSEMBLY

(71) Applicant: Battelle Memorial Institute, Columbus, OH (US)

(72) Inventors: Gaymon M. DAVIS, Columbus, OH (US); Mark J. SOPER, Hilliard, OH (US); Luke T. KELM, Columbus, OH (US); Jerry L. DURHAM, Bexley, OH (US)

(21) Appl. No.: 18/754,480

(22) Filed: Jun. 26, 2024

Related U.S. Application Data
(60) Provisional application No. 63/511,230, filed on Jun. 30, 2023.

(51) Int. Cl. B60G 11/113; B60G 11/12

(52) U.S. Cl. CPC B60G 11/113; B60G 11/12; B60G 2202/112; B60G 2204/41; B60G 2204/43

(57) ABSTRACT

An articulating leaf spring suspension (ALSS) comprising a bushing assembly and a base component; a first bushing pillar having a first bushing; and a second bushing pillar having a second bushing distally opposed from the base component. The ALSS includes a cap secured to a top of the bushing pillars and extending along the bushing assembly, the cap comprising an arch middle portion between a gap between the first and second bushing pillars, the arch middle portion, the first and second bushing pillars, and the base component forming an opening. The ALSS includes a bracket assembly including a first bracket secured to an exterior surface of the bushings and a second bracket secured to an exterior surface of the bushings. The ALSS includes a leaf spring interface plate disposed below and parallel to the base component and secured to the brackets against a bottom surface of the base component.

### RELATED APPLICATIONS

This patent application claims priority to U.S. Provisional Application No. 63/511,230, filed Jun. 30, 2023, the entirety of which is incorporated herein by reference.

### TECHNICAL FIELD

The present disclosure relates to suspension components for vehicles.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates a perspective view of an articulating leaf spring suspension apparatus, in accordance with several embodiments of the present disclosure;

FIG. 2 illustrates a perspective view of an articulating rear suspension apparatus, in accordance with several embodiments of the present disclosure;

FIG. 3 illustrates a perspective view of a bushing assembly for an articulating bracket for a leaf spring suspension, according to one embodiment of the present disclosure;

FIG. 4 illustrates a perspective view of a cap and hangar assembly for an articulating bracket for a leaf spring suspension, according to one embodiment of the present disclosure;

FIG. 5 illustrates a perspective view of an articulating rear suspension apparatus, according to one embodiment of the present disclosure;

FIG. 6 illustrates a top view of an articulating rear suspension apparatus, according to one embodiment of the present disclosure;

FIG. 7 illustrates an interior side view of an articulating rear suspension apparatus, according to one embodiment of the present disclosure;

FIG. 8 illustrates a left side view of an articulating rear suspension apparatus, according to one embodiment of the present disclosure; and

FIG. 9 illustrates an exterior side view of an articulating rear suspension apparatus, according to one embodiment of the present disclosure.

Although the following Detailed Description will proceed with reference being made to illustrative embodiments, many alternatives, modifications and variations thereof will be apparent to those skilled in the art.

### DETAILED DESCRIPTION

Embodiments of the present invention recognize that existing leaf spring suspensions carry large amounts of weight but are over constrained due to the excessive load. This over constraint leads to induced stress on the leaf spring suspensions when the suspension bracket articulates. Therefore, embodiments described herein provide a new axle-to-leaf spring mount that incorporates limited rotation in a direction parallel to the axis of the vehicle. As a result, adding a rotational degree of freedom would make it easier for the suspension to articulate and reduce the amount of induced stress. As an added improvement, embodiments described herein provide increased range-of-motion for the vehicle axle in off-road or uneven terrain conditions. Additionally, embodiments described herein result in lower stresses in the axle housing resulting in longer life. This is most effective for heavily loaded vehicles with a high-count leaf spring stack including, but not limited to, armored vehicles.

Embodiments described herein provide an articulating leaf spring suspension configured to provide a new degree of freedom in vehicle suspensions. For example, adding a rotational degree of freedom between the axle housing and leaf springs improves the stress experienced on a vehicle suspension system. Therefore, embodiments described herein reduce or eliminate the over constraint placed on the vehicle suspension components without degrading load carrying capabilities or on-road handling characteristics. As a result, due to the additional pivot axis, the axle housing is able to pivot independently of the spring stack, thus reducing and/or eliminating stresses induced in the springs or housing.

Embodiments of the invention will now be described with reference to the Figures.

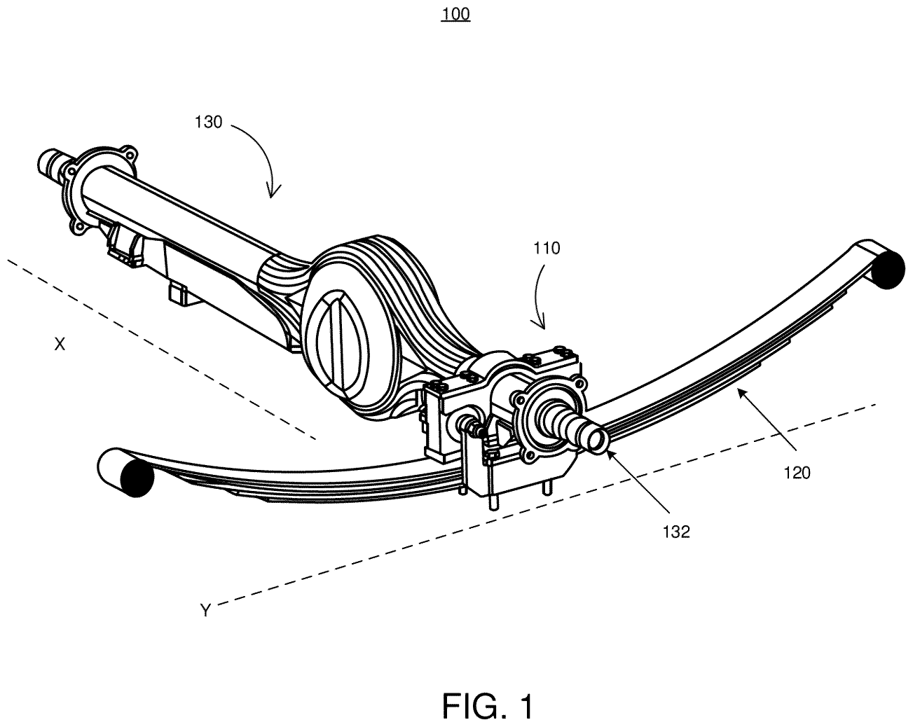

FIG. 1 illustrates a perspective view of an example suspension system 100 in accordance with several embodiments of the present disclosure. The suspension system 100 includes an articulating bracket assembly 110 clamped around a rear axle housing 130 and disposed on a leaf spring suspension 120. The articulating bracket assembly 110 enables the leaf spring suspension 120 and/or axle 130 to pivot relative to one another in the direction of the long axis of the axle 130 (labelled X in FIG. 1), thus reducing stresses experienced by axle housing 130 during travel. The articulating bracket assembly 110 may include rubber bushing components configured to add additional degrees of movement within the confines of the vehicle suspension system so that less impact is experienced by axle housing 130. In addition, pivot points of the articulating bracket assembly 110 are disposed in the plane of the long axis (X) of the axle 130, thus enabling pivoting of the leaf spring 120 and/or axle 130 relative to one another without increasing the overall distance between the leaf spring 120 and the axle 130 (and thus, articulating bracket assembly 110 of the present disclosure does not increase the overall height of a vehicle having the suspension system 100 installed).

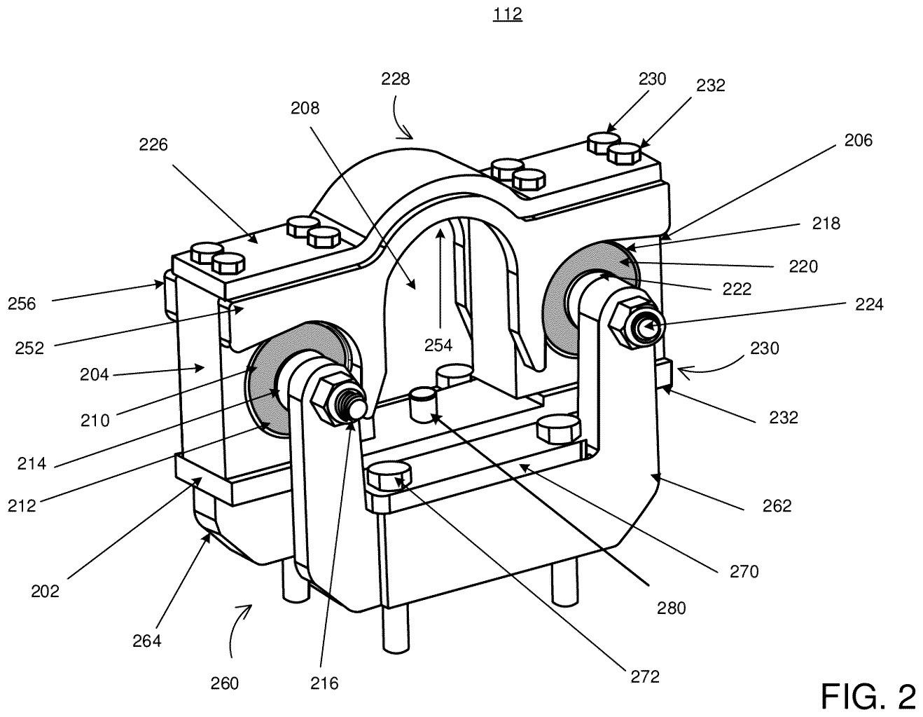

FIG. 2 illustrates a perspective view of the articulating bracket assembly 120 in accordance with several embodiments of the present disclosure. As used in the description below, “exterior” refers to the face of the bracket 112 that directed away from the axle 130, and “interior” refers to the face of the bracket 112 that directed toward the axle 130. The articulating bracket assembly 112 includes a base plate 202, a first bushing pillar 204 disposed on a first end of the base plate 202, and a second busing pillar 206 disposed on a second end of the base plate 202. A gap or opening 208 is defined between the first and second pillars 204/206, where the gap 208 is dimensioned to receive an end 132 of an axle 130. The first pillar 204 defines an opening in which a first bushing assembly 210 is disposed. The first bushing assembly 210 extends through the thickness of the first pillar 204 from an exterior face of the pillar 204 (the face illustrated in FIG. 2) to an interior face of the pillar 204. The first bushing assembly 210 includes a first hollow sleeve 214 surrounded by first bushing 212. The sleeve is dimensioned to receive a bolt 216 therethrough. The first bushing 214 may be formed of a flexible material such as, for example, rubber, plastic, etc. The position of the first bushing assembly 210 within the first pillar 204 is selected so that the center of the sleeve 214 is approximately of a plane defined through the center of the long axis of the axle 130, i.e., the center of the sleeve 214 is approximately coplanar with the long axis (X) of the axle 130.

Similar to the first pillar 204, the second pillar 206 defines an opening in which a second bushing assembly 220 is disposed. The second bushing assembly 220 extends through the thickness of the second pillar 206 from an exterior face of the pillar 206 (the face illustrated in FIG. 2) to an interior face of the pillar 206. The second bushing assembly 220 includes a second hollow sleeve 222 surrounded by second bushing 220. The sleeve 220 is dimensioned to receive a bolt 224 therethrough. The second bushing 220 may be formed of a flexible material such as, for example, rubber, plastic, etc. The position of the second bushing assembly 218 within the second pillar 206 is selected so that the center of the sleeve 222 is approximately of a plane defined through the center of the long axis of the axle 130, i.e., the center of the sleeve 222 is approximately coplanar with the long axis (X) of the axle 130.

The articulating bracket assembly 120 may also include a cap component 226 secured to a top portion of the first and second pillars 204/206 and extending along a length of base component 202. The cap component 226 comprising an arched middle portion 228, the arch 228 spanning the gap 208 between the first and second pillars 204/206. The cap component 226 may be bolted to, or otherwise secured to, the top of the first and second pillars 204/206, as illustrated using a plurality of bolts such as bolts 230 and 232.

The articulating bracket assembly 112 may also include one or more top axle constraints to ensure a secure fit of the bracket assembly 112 around the end of the axle 130. For example, the articulating bracket assembly 120 may include an exterior constraint component 252 secured to an uppermost exterior surface of the first and second bushing pillars 204/206 and having an arched middle section 254 that fits within the arched middle portion 228 of the cap component 226. The arched middle section 254 is dimensioned to contact the end 132 of axle housing 130, thus securing the end 132 of the axle 130 against the arched middle section 254, the pillars 204/206 and the base plate 202. In some embodiments, the articulating bracket assembly 112 may also include an interior constraint component 254 secured to an uppermost exterior surface of the first and second bushing pillars 204/206, and having a shape and function substantially similar to the exterior constraint 252, described above. In some embodiments, the exterior and/or interior constraints 252/256 may be welded to the first and second bushing pillars 204/206. In other embodiments, the exterior and interior constraints 252/256 may be bolted (not shown) to the first and second bushing pillars 204/206. The top constraints 252 and/or 256 generally provide additional strength and material thickness around the top region of the axle 130. As illustrated, the cap component 226 has a width to cover the top surfaces of the first and second bushing pillars 204/206 and the exterior and interior constraints 252/256, such that top surfaces of the exterior and interior constraints 252/256 are coplanar with the top surfaces of the first and second bushing pillars 204/206, and thus the cap 226 “covers” the top surfaces of the exterior and interior constraints 252/256. In other embodiments, the exterior and interior constraints 252/256 and the cap 226 may be formed as a unitary structure.

The articulating rear suspension apparatus 200 may also include a bracket component 260 (e.g., exterior bracket component 262 and interior bracket component 264) secured to bushing assembly 112 using bolts (e.g., plate bolt 272) extended through upper distally opposed openings aligned with first rubber bushing 220 and second rubber bushing 222. For example, bracket component 260 may include exterior bracket component 262 secured to first bushing component 210 via a first bushing bolt (e.g., first bolt 214) and secured to second bushing component 212 via a second bushing bolt (e.g., second bolt 216). Further, bracket component 260 may include interior bracket component 264 secured to first bushing component 210 via first bushing bolt (e.g., first bolt 214) and secured to second bushing component 212 via second bushing bolt (e.g., second bolt 216).

In an embodiment, exterior bracket component 260 may be secured distally opposed and parallel to interior bracket component 264 via leaf spring interface plate 270 disposed below and parallel to base assembly component 230. In an embodiment, leaf spring interface plate 270 may be perpendicular to exterior bracket component 262 and interior bracket component 264.

In an embodiment, articulating rear suspension apparatus 200 may include dowel pin 280 fixedly extended through a center portion of base assembly component 230, the center portion contiguous with and disposed between the first end 232 and the second end 234 of base assembly component 230.

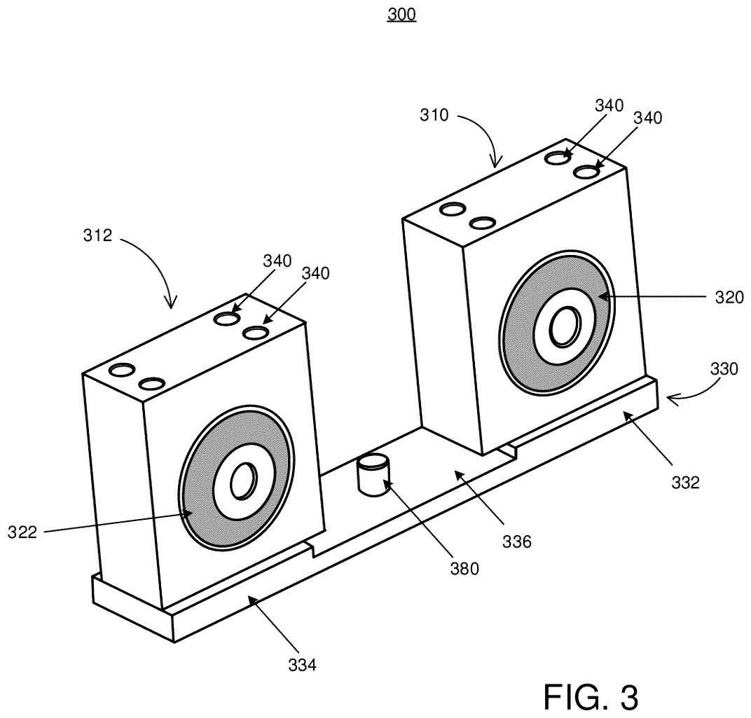

FIG. 3 illustrates a perspective view of a bushing assembly 300 for an articulating bracket for a leaf spring suspension, according to one embodiment of the present disclosure.

In an embodiment, bushing assembly 300 may include first bushing component 310 distally opposed from second bushing component 312 and both fixed on a base assembly component 330 having center portion 336 therebetween. In an embodiment, first bushing component 310 may include first rubber bushing 320 disposed within the center and second bushing component 312 may include second rubber bushing 322 disposed within the center.

In an embodiment, base assembly component 330 may include first end 332 distally opposed from second end 334 having center portion 336 disposed therebetween. Further, base assembly component 330 may include dowel pin 380 at the center of center portion 336 configured to be secured to an axle housing bracket assembly component to secure the axle housing to articulating leaf spring suspension bracket 200.

In an embodiment, first bushing component 310 and second bushing component 312 may include one or more bolt receptors 340 in a top portion thereof and configured to receive bolts 246 to secure bushing assembly 300 to cap component 226.

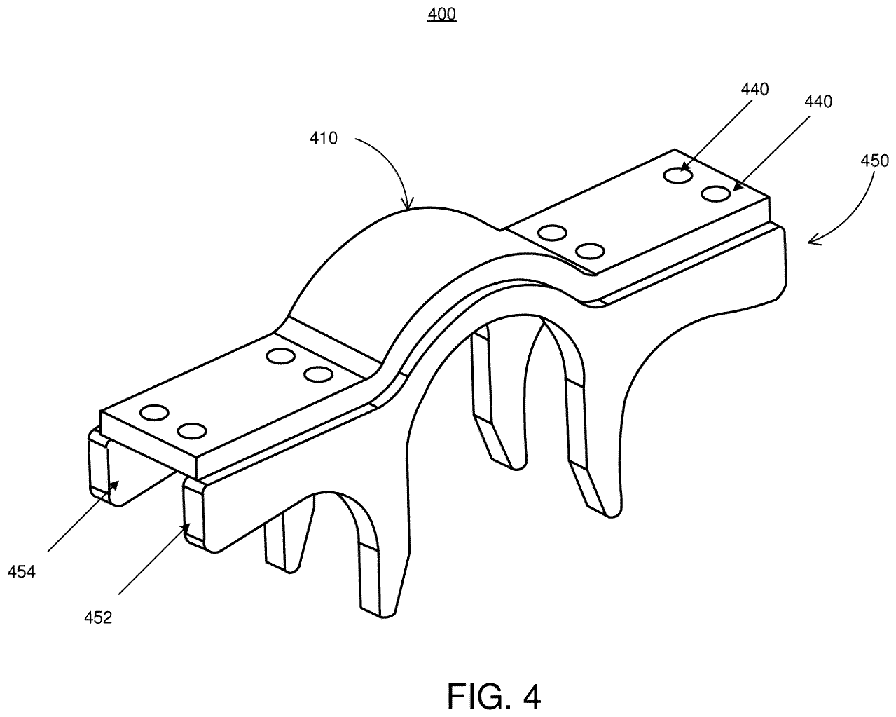

FIG. 4 illustrates a perspective view of a cap and hangar assembly 400 for an articulating bracket for a leaf spring suspension, according to one embodiment of the present disclosure.

In an embodiment, cap and hangar assembly 400 may include cap component 410 secured to hangar component 450, wherein cap component 410 may include one or more cap bolt receptors 440 to receive bolts to secure cap and hangar assembly 400 to bushing assembly 300 via the bolts 246.

In an embodiment, hanger component 450 may include exterior hangar component 452 and interior hangar component 454 wherein an upper surface of exterior hangar component 452 and interior hangar component 454 may be secured to an under surface of cap component 410.

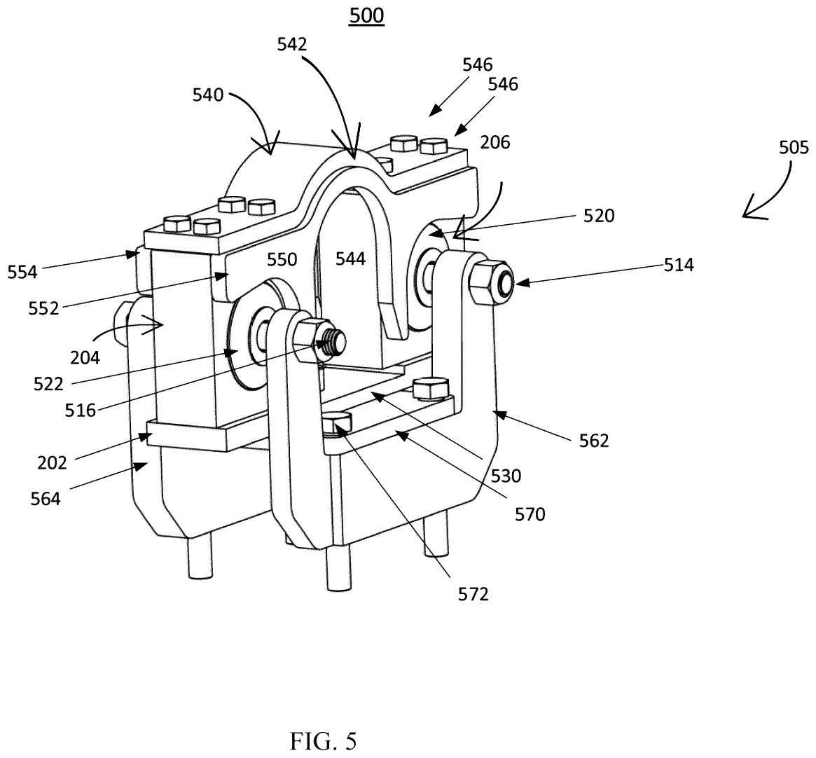

FIG. 5 illustrates a perspective view of an articulating rear suspension apparatus 500, according to one embodiment of the present disclosure.

In an embodiment, an articulating rear suspension apparatus 500 may include components shown in FIG. 5 corresponding to the embodiments described in FIG. 2. For example, in an embodiment, articulating rear suspension apparatus 500 may include bushing assembly 505 component comprising first bushing component 510 having first rubber bushing 520 centered within to receive first bolt 514 therethrough, first bushing component 510 secured to first end 532 of base assembly component 530. Further, articulating rear suspension apparatus 500 may include bushing assembly 505 component having second bushing component 512 having second rubber bushing 522 centered within to receive second bolt 516 therethrough, second bushing component 512 vertically secured to second end 534 distally opposed from first end 532 of base assembly 530 component.

Furthermore, articulating rear suspension apparatus 500 may include cap component 540 secured to a top portion and extending along a length of bushing assembly 505, cap component 540 comprising concaved middle portion 542 between a gap defined between first bushing component 510 and second bushing component 512, concaved middle portion 542 and base assembly component 530 forming an opening 544 to receive end 132 of axle housing 130.

In an embodiment, articulating rear suspension apparatus 500 may include hangar component 550 secured to an uppermost exterior surface of bushing assembly 505 having a middle section forming an arch consistent with concaved middle portion 542 between first bushing component 510 and second bushing component 512, the arch configured to contact the end 132 of axle housing 130. In an embodiment, hangar component 550 may further include exterior hangar component 552 distally opposed from interior hangar component 554 bracketing the uppermost exterior surface of bushing assembly 505. For example, an upper surface of exterior hangar component 552 and interior hangar component 554 may be secured to an under surface of cap component 540. Further, in an embodiment, exterior hangar component 552 may be configured to cover a first exterior surface of bushing assembly 505 down to a first upper edge of first rubber bushing 520 and interior hangar component 554 may be configured to cover a second exterior surface of bushing assembly 505 down to a second upper edge of second rubber bushing 522. Furthermore, in an embodiment, interior hangar component 554 may be secured to a second exterior surface of first bushing component 510 and a second exterior surface of second bushing component 512 forming an interior arch between first bushing component 510 and second bushing component 512.

In an embodiment, articulating rear suspension apparatus 500 may include bracket component 560 (e.g., exterior bracket component 562 and interior bracket component 564) secured to bushing assembly 505 using bolts (e.g., plate bolt 572) extended through upper distally opposed openings aligned with first rubber bushing 520 and second rubber bushing 522. For example, bracket component 560 may include exterior bracket component 562 secured to first bushing component 510 via a first bushing bolt (e.g., first bolt 514) and secured to second bushing component 512 via a second bushing bolt (e.g., second bolt 516). Further, bracket component 560 may include interior bracket component 564 secured to first bushing component 510 via first bushing bolt (e.g., first bolt 514) and secured to second bushing component 512 via second bushing bolt (e.g., second bolt 516).

In an embodiment, exterior bracket component 560 may be secured distally opposed and parallel to interior bracket component 564 via leaf spring interface plate 570 disposed below and parallel to base assembly component 530. In an embodiment, leaf spring interface plate 570 may be perpendicular to exterior bracket component 562 and interior bracket component 564.

In an embodiment, articulating rear suspension apparatus 500 may include dowel pin 580 fixedly extended through a center portion of base assembly component 530, the center portion contiguous with and disposed between the first end 532 and the second end 534 of base assembly component 530.

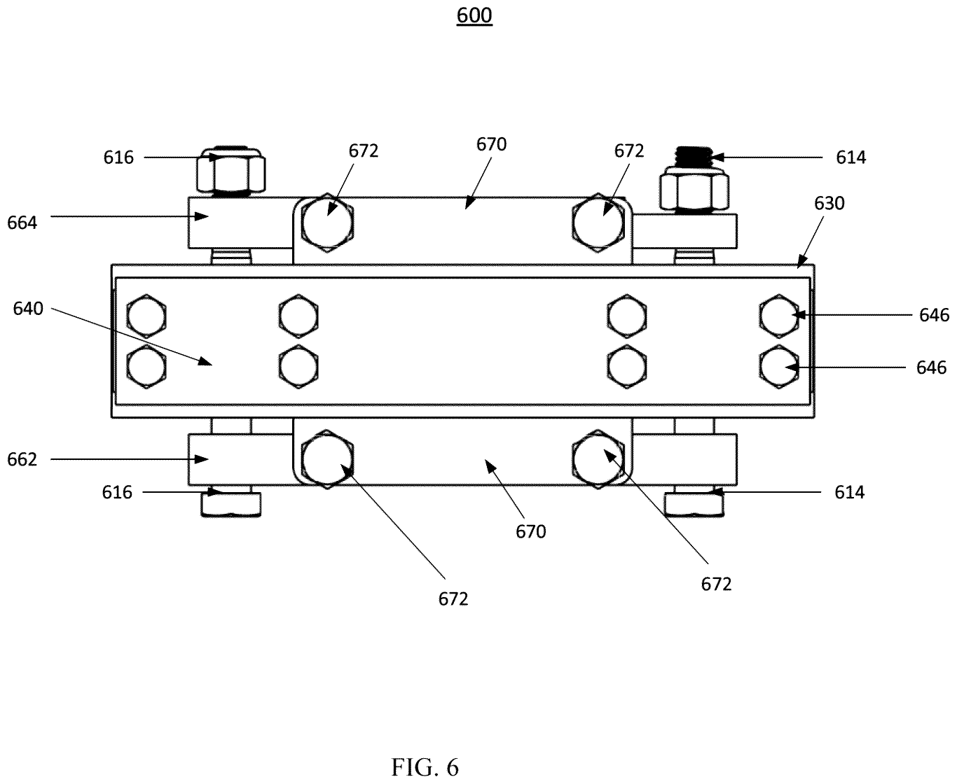

FIG. 6 illustrates a top view of an articulating rear suspension apparatus 600, according to one embodiment of the present disclosure.

In an embodiment, articulating rear suspension apparatus 600 is shown from a top view and is configured to embody the features of the invention as described above herein. For example, first bolt 614 and second bolt 616 are shown as providing some of the components configured to secure the bracket component (e.g., exterior bracket component 662, interior bracket component 664) to the bushing assembly. Further, in an embodiment, cap bolts 646 are shown as providing some of the components configured to secure cap component 640 to the bushing assembly. Furthermore, leaf spring interface plate 670 is shown as being secured to the bracket component (e.g., exterior bracket component 662, interior bracket component 664) using one or more plate bolts 672.

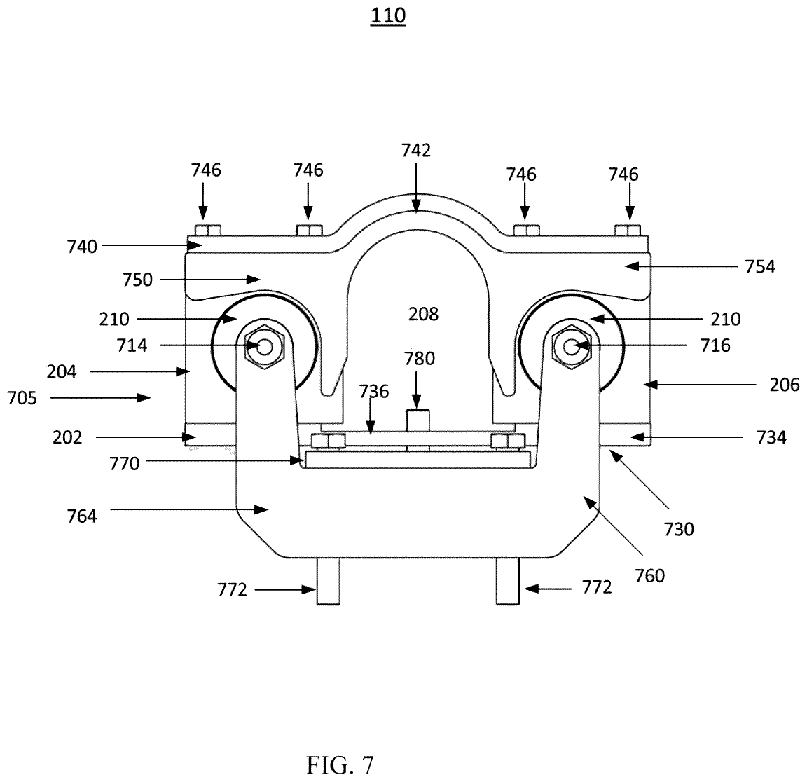

FIG. 7 illustrates an interior side view of an articulating rear suspension apparatus 700, according to one embodiment of the present disclosure.

In an embodiment, the interior face of articulating rear suspension apparatus 700 is shown with corresponding components consistent with those described in FIG. 2 and FIG. 5 above herein. For example, in an embodiment, articulating rear suspension apparatus 500 may include bushing assembly 705 component comprising first bushing component 710 having first rubber bushing 720 centered within to receive first bolt 714 therethrough, first bushing component 710 secured to first end 732 of base assembly component 730. Further, articulating rear suspension apparatus 700 may include bushing assembly 705 component having second bushing component 712 having second rubber bushing 722 centered within to receive second bolt 716 therethrough, second bushing component 712 vertically secured to second end 734 distally opposed from first end 732 of base assembly 730 component.

Furthermore, articulating rear suspension apparatus 700 may include cap component 740 secured to a top portion and extending along a length of bushing assembly 705, cap component 740 comprising concaved middle portion 742 between a gap defined between first bushing component 710 and second bushing component 712, concaved middle portion 742 and base assembly component 730 forming an opening 744 to receive end 132 of axle housing 130.

In an embodiment, articulating rear suspension apparatus 700 may include hangar component 750 secured to an uppermost exterior surface of bushing assembly 705 having a middle section forming an arch consistent with concaved middle portion 742 between first bushing component 710 and second bushing component 712, the arch configured to contact the end 132 of axle housing 130. In an embodiment, hangar component 750 may further include exterior hangar component 752 (not shown) distally opposed from interior hangar component 754 bracketing the uppermost exterior surface of bushing assembly 705. For example, an upper surface of exterior hangar component 752 (not shown) and interior hangar component 754 may be secured to an under surface of cap component 740. Further, in an embodiment, exterior hangar component 752 (not shown) may be configured to cover a first exterior surface of bushing assembly 705 down to a first upper edge of first rubber bushing 720 and interior hangar component 754 may be configured to cover a second exterior surface of bushing assembly 705 down to a second upper edge of second rubber bushing 722. Furthermore, in an embodiment, interior hangar component 754 may be secured to a second exterior surface of first bushing component 710 and a second exterior surface of second bushing component 712 forming an interior arch between first bushing component 710 and second bushing component 712.

In an embodiment, articulating rear suspension apparatus 700 may include bracket component 760 (e.g., exterior bracket component 762 (not shown) and interior bracket component 764) secured to bushing assembly 705 using bolts (e.g., plate bolt 772) extended through upper distally opposed openings aligned with first rubber bushing 720 and second rubber bushing 722. For example, bracket component 760 may include exterior bracket component 762 (not shown) secured to first bushing component 710 via a first bushing bolt (e.g., first bolt 714) and secured to second bushing component 712 via a second bushing bolt (e.g., second bolt 716). Further, bracket component 760 may include interior bracket component 764 secured to first bushing component 710 via first bushing bolt (e.g., first bolt 714) and secured to second bushing component 712 via second bushing bolt (e.g., second bolt 716).

In an embodiment, exterior bracket component 760 may be secured distally opposed and parallel to interior bracket component 764 via leaf spring interface plate 770 disposed below and parallel to base assembly component 730. In an embodiment, leaf spring interface plate 770 may be perpendicular to exterior bracket component 762 (not shown) and interior bracket component 764.

In an embodiment, articulating rear suspension apparatus 700 may include dowel pin 780 fixedly extended through a center portion of base assembly component 730, the center portion contiguous with and disposed between the first end 732 and the second end 734 of base assembly component 730.

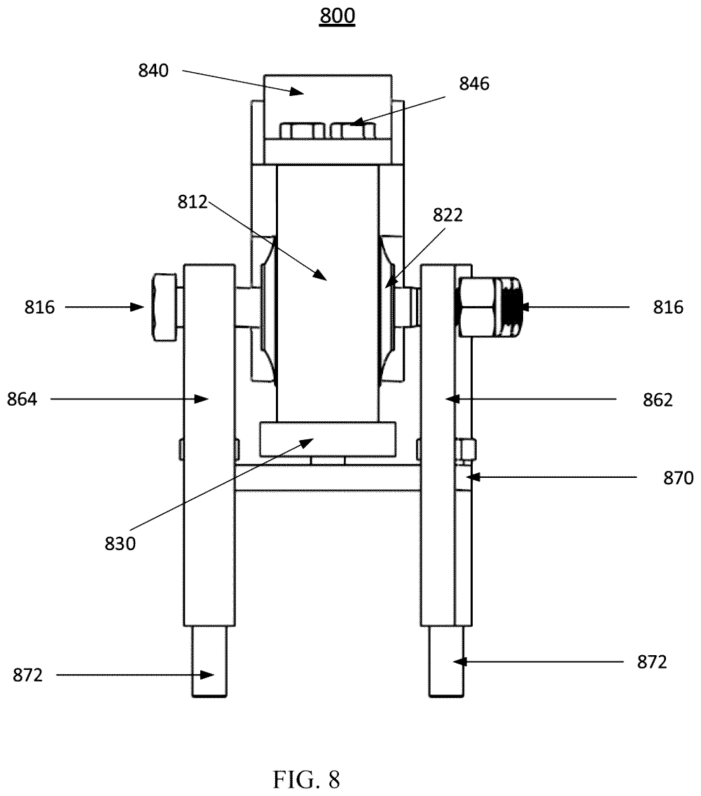

FIG. 8 illustrates a left side view of an articulating rear suspension apparatus 800, according to one embodiment of the present disclosure.

In an embodiment, articulating rear suspension apparatus 800 may include the components shown and configured to embody the features of the invention as described above herein. For example, articulating rear suspension apparatus 800 may include second bushing component 812 secured to bracket component (e.g., exterior bracket component 862, interior bracket component 864) via one or more bolts (e.g., second bolt 816), wherein second bushing component 812 may be secured to base assembly component 830. Further, bracket components (e.g., exterior bracket component 862, interior bracket component 864) may be configured to be secured to leaf spring interface plate 870 via one or more plate bolts 872. Additionally, cap component 840 may be secured to bushing component via one or more cap bolts 846 consistent with the embodiments described above herein.

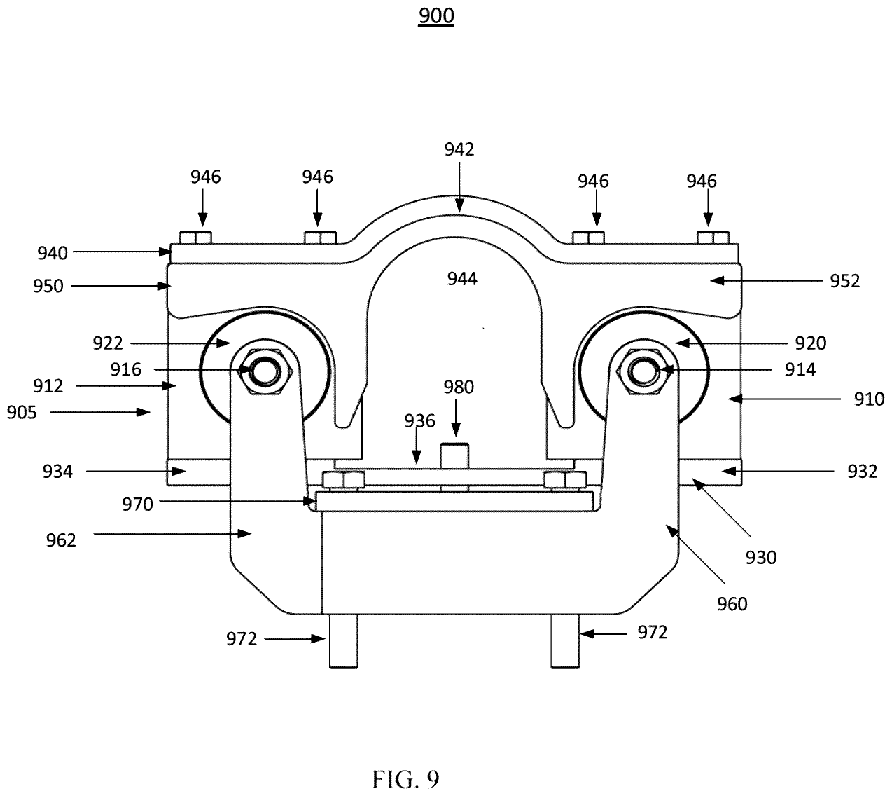

FIG. 9 illustrates an exterior side view of an articulating rear suspension apparatus 900, according to one embodiment of the present disclosure.

In an embodiment, the exterior face of articulating rear suspension apparatus 900 is shown with corresponding components consistent with those described in FIG. 2, FIG. 5, and FIG. 7 above herein. For example, in an embodiment, articulating rear suspension apparatus 900 may include bushing assembly 905 component comprising first bushing component 910 having first rubber bushing 920 centered within to receive first bolt 914 therethrough, first bushing component 910 secured to first end 932 of base assembly component 930. Further, articulating rear suspension apparatus 900 may include bushing assembly 905 component having second bushing component 912 having second rubber bushing 922 centered within to receive second bolt 916 therethrough, second bushing component 912 vertically secured to second end 934 distally opposed from first end 932 of base assembly 930 component.

Furthermore, articulating rear suspension apparatus 900 may include cap component 940 secured to a top portion and extending along a length of bushing assembly 905, cap component 940 comprising concaved middle portion 942 between a gap defined between first bushing component 910 and second bushing component 912, concaved middle portion 942 and base assembly component 930 forming an opening 944 to receive end 132 of axle housing 130.

In an embodiment, articulating rear suspension apparatus 900 may include hangar component 950 secured to an uppermost exterior surface of bushing assembly 905 having a middle section forming an arch consistent with concaved middle portion 942 between first bushing component 910 and second bushing component 912, the arch configured to contact the end 132 of axle housing 130. In an embodiment, hangar component 950 may further include exterior hangar component 952 distally opposed from interior hangar component 954 (not shown) bracketing the uppermost exterior surface of bushing assembly 905. For example, an upper surface of exterior hangar component 952 and interior hangar component 954 (not shown) may be secured to an under surface of cap component 940. Further, in an embodiment, exterior hangar component 952 may be configured to cover a first exterior surface of bushing assembly 905 down to a first upper edge of first rubber bushing 920 and interior hangar component 954 (not shown) may be configured to cover a second exterior surface of bushing assembly 905 down to a second upper edge of second rubber bushing 922. Furthermore, in an embodiment, interior hangar component 954 (not shown) may be secured to a second exterior surface of first bushing component 910 and a second exterior surface of second bushing component 912 forming an interior arch between first bushing component 910 and second bushing component 912.

In an embodiment, articulating rear suspension apparatus 900 may include bracket component 960 (e.g., exterior bracket component 962 and interior bracket component 964 (not shown)) secured to bushing assembly 905 using bolts (e.g., plate bolt 972) extended through upper distally opposed openings aligned with first rubber bushing 920 and second rubber bushing 922. For example, bracket component 960 may include exterior bracket component 962 secured to first bushing component 910 via a first bushing bolt (e.g., first bolt 914) and secured to second bushing component 912 via a second bushing bolt (e.g., second bolt 916). Further, bracket component 960 may include interior bracket component 964 (not shown) secured to first bushing component 910 via first bushing bolt (e.g., first bolt 914) and secured to second bushing component 912 via second bushing bolt (e.g., second bolt 916).

In an embodiment, exterior bracket component 960 may be secured distally opposed and parallel to interior bracket component 964 (not shown) via leaf spring interface plate 970 disposed below and parallel to base assembly component 930. In an embodiment, leaf spring interface plate 970 may be perpendicular to exterior bracket component 962 and interior bracket component 964 (not shown).

In an embodiment, articulating rear suspension apparatus 900 may include dowel pin 980 fixedly extended through a center portion of base assembly component 930, the center portion contiguous with and disposed between the first end 932 and the second end 934 of base assembly component 930.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

What is claimed is:

1. An articulating leaf spring suspension apparatus, comprising:
a bushing assembly comprising:
a base component;
a first bushing pillar having a first bushing, the first bushing pillar secured to a first end of a base component; and
a second bushing pillar having a second bushing, the second bushing pillar secured to a second end of the base component and distally opposed from the first end of the base component;
a cap secured to a top portion of the first and second bushing pillars and extending along a length of the bushing assembly, the cap comprising an arch middle portion between a gap defined between the first and second bushing pillars, the arch middle portion, the first and second bushing pillars, and the base component forming an opening to receive an end of an axle housing;
a bracket assembly comprising a first bracket secured to an exterior surface of the first and second bushings and a second bracket secured to an exterior surface of the first and second bushings; and
a leaf spring interface plate disposed below and parallel to the base component and secured to the first and second brackets against a bottom surface of the base component.

2. The articulating leaf spring suspension apparatus of claim 1, further comprising:
a dowel pin fixedly extended through a center portion of the base component and extending within the opening defined by the gap defined between the first and second bushing pillars, the arch middle portion, the first and second bushing pillars, and the base component.

3. The articulating leaf spring suspension apparatus of claim 1, further comprising:
a hangar component secured to an uppermost exterior surface of the bushing assembly having a middle section forming an arch consistent with the concaved middle portion between the first bushing component and the second bushing component, the arch configured to contact the end of the axle housing;
an exterior bracket component secured to the first bushing component via a first bushing bolt and secured to the second bushing component via a second bushing bolt; and
an interior bracket component secured to the first bushing component via the first bushing bolt and secured to the second bushing component via the second bushing bolt.

4. The articulating leaf spring suspension apparatus of claim 1, wherein the exterior bracket component is secured distally opposed and parallel to the interior bracket component via a leaf spring interface plate disposed below and parallel to the base assembly component.

5. The articulating suspension system of claim 4, wherein the leaf spring interface plate is perpendicular to the exterior bracket component and the interior bracket component.

6. The articulating suspension system of claim 1, wherein the hangar component further comprises an exterior hangar component distally opposed from an interior hangar component bracketing the uppermost exterior surface of the bushing assembly.

7. The articulating suspension system of claim 6, wherein an upper surface of the exterior hangar component and the interior hangar component are secured to an under surface of the cap component.

8. The articulating suspension system of claim 6, wherein the exterior hangar component covers a first exterior surface of the bushing assembly down to a first upper edge of the first rubber bushing.

9. The articulating suspension system of claim 6, wherein the interior hangar component covers a second exterior surface of the bushing assembly down to a second upper edge of the second rubber bushing.

10. The articulating suspension system of claim 6, wherein the interior hangar component is secured to a second exterior surface of the first bushing component and a second exterior surface of the second bushing component forming an interior arch between the first bushing component and the second bushing component.

11. An articulating leaf spring suspension apparatus, comprising:
a bushing assembly comprising:
a base component;
a first bushing pillar having a first bushing, the first bushing pillar secured to a first end of a base component; and
a second bushing pillar having a second bushing, the second bushing pillar secured to a second end of the base component and distally opposed from the first end of the base component;
a cap secured to a top portion of the first and second bushing pillars and extending along a length of the bushing assembly, the cap comprising an arch middle portion between a gap defined between the first and second bushing pillars, the arch middle portion, the first and second bushing pillars, and the base component forming an opening to receive an end of an axle housing;
a bracket assembly comprising a first bracket secured to an exterior surface of the first and second bushings and a second bracket secured to an exterior surface of the first and second bushings;
a leaf spring interface plate disposed below and parallel to the base component and secured to the first and second brackets against a bottom surface of the base component;
a hangar component secured to an uppermost exterior surface of the bushing assembly having a middle section forming an arch consistent with the concaved middle portion between the first bushing component and the second bushing component, the arch configured to contact the end of the axle housing;
an exterior bracket component secured to the first bushing component via a first bushing bolt and secured to the second bushing component via a second bushing bolt; and
an interior bracket component secured to the first bushing component via the first bushing bolt and secured to the second bushing component via the second bushing bolt.

12. The articulating leaf spring suspension apparatus of claim 1, further comprising:
a dowel pin fixedly extended through a center portion of the base component and extending within the opening defined by the gap defined between the first and second bushing pillars, the arch middle portion, the first and second bushing pillars, and the base component.

13. The articulating leaf spring suspension apparatus of claim 11, wherein the exterior bracket component is secured distally opposed and parallel to the interior bracket component via a leaf spring interface plate disposed below and parallel to the base assembly component.

14. The articulating suspension system of claim 13, wherein the leaf spring interface plate is perpendicular to the exterior bracket component and the interior bracket component.

15. The articulating suspension system of claim 11, wherein the hangar component further comprises an exterior hangar component distally opposed from an interior hangar component bracketing the uppermost exterior surface of the bushing assembly.

16. The articulating suspension system of claim 15, wherein an upper surface of the exterior hangar component and the interior hangar component are secured to an under surface of the cap component.

17. The articulating suspension system of claim 15, wherein the exterior hangar component covers a first exterior surface of the bushing assembly down to a first upper edge of the first rubber bushing.

18. The articulating suspension system of claim 15, wherein the interior hangar component covers a second exterior surface of the bushing assembly down to a second upper edge of the second rubber bushing.

19. The articulating suspension system of claim 15, wherein the interior hangar component is secured to a second exterior surface of the first bushing component and a second exterior surface of the second bushing component forming an interior arch between the first bushing component and the second bushing component.
